(19) United States
(12) Patent Application Publication
(10) Pub. No.: US 2009/0294038 A1
(43) Pub. Date: Dec. 3, 2009

(54) Intermittent Film Drive and Method

(75) Inventors: MANFRED JURKEWITZ, Wiesloch (DE); STEFAN MAIER, Dielheim (DE); JURGEN RAUTERT, Heidelberg (DE); JOACHIM SONNENSCHEIN, Muhltal (DE); ALEXANDER WEBER, Weinheim (DE)

Correspondence Address: LERNER GREENBERG STEMER LLP, P O BOX 2480, HOLLYWOOD, FL, 33022-2480, US

(73) Assignee: Heidelberger Druckmaschinen AG, Heidelberg (DE)

(21) Appl. No.: 12/472,410

(22) Filed: May 27, 2009

(30) Foreign Application Priority Data
May 27, 2008 (DE) 10 2008 025 285.9

(51) Int. Cl. B44C 1/16

(52) U.S. Cl. 156/234; 156/361

(57) ABSTRACT

A method and an apparatus for reducing web tension change during intermittent driving of a transfer film in a film transfer unit, include severely impairing the web tension by contact sections before and after a transfer nip of the film transfer unit as the transfer film runs through a channel at the transfer nip. In order to reduce the web tension changes, front and/or rear guide elements before and after the transfer nip are moved time-asynchronously in relation to one other in order to at least reduce web tension fluctuations of the transfer film as it passes through the transfer nip.

### CROSS-REFERENCE TO RELATED APPLICATION

This application claims the priority, under 35 U.S.C. §119, of German Patent Application DE 10 2008 025 285.9, filed May 27, 2008; the prior application is herewith incorporated by reference in its entirety.

### BACKGROUND OF THE INVENTION

1. Field of the Invention

The present invention relates to a method and an apparatus for transferring a transfer layer adhering to a carrier film because of a release layer, under the action of pressure, to flat material at least partly coated with an adhesive.

More specifically, the invention relates to a method for transferring a transfer layer of a transfer film from a carrier film of the transfer film to a printing material. The method includes applying adhesive to at least some areas of the printing material in an applicator, leading the printing material, together with the transfer film, through a transfer nip in a transfer unit, transferring the transfer layer to the printing material in the transfer nip, during the transfer, moving the transfer film through the transfer nip at a first speed, being substantially equal to a speed of the printing material, when no transfer is taking place, moving the transfer film through the transfer nip at a second speed being lower than the first speed, and accelerating the transfer film to the first speed and braking the transfer film to the second speed by adjusting front guide elements disposed before the transfer nip and/or rear guide elements disposed after the transfer nip.

Additionally, the invention relates to a film transfer apparatus, including an applicator for applying an adhesive, at least in some areas, to a printing material led through the applicator, a transfer unit disposed downstream of the applicator and having a transfer nip for transferring a transfer layer of a transfer film from a carrier film of the transfer film to the printing material, at least in some areas, a supply roll for providing the transfer film, a take-up roll for accommodating used transfer film, and adjustable guide elements disposed before and/or after the transfer nip to match a speed of movement of the transfer film, at least from time to time, to a speed of the printing material in the transfer nip.

Generic film transfer apparatuses are used in the finishing of printed products, for example in order to produce gloss effects. The machines can be subdivided into hot embossing film machines and cold film embossing machines. In the latter, the transfer layer is only transferred to the flat material, i.e. to a printing material such as a sheet, under pressure but not additionally under the action of heat. As a rule, in cold film transfer apparatuses, i.e. cold film transfer devices having a printing unit which is placed upstream of the transfer apparatus, adhesive is printed, so that there remains on the sheet a printed image of adhesive which, within a film transfer unit, is able to pull a corresponding transfer layer off the transfer film, so that the transfer layer adheres to the sheet in some areas. In that case, the transfer layer can be transferred partially in the transfer nip under the action of pressure, substantially in the areas to which adhesive has been applied.

The problem with that film transfer technique is that the transfer film has to be moved at the same speed as the printing material during the transfer and that, as a rule, only small areas on the printing material are to be covered with the transfer layer. In particular, a transfer cylinder involved in the transfer nip often has a so-called channel, in which a printing blanket can be fixed. In the region of that channel, no transfer of the transfer layer through the use of pressure can be carried out. Therefore, the process should always be controlled in such a way that the printed material dips into the transfer nip between the transfer cylinder and an impression cylinder when the channel cannot be in the area of the printing material. Other areas, in which transfer film is transported through the transfer nip without being used, are areas in which no transfer layer is to be transferred to the printing material.

In order to use the transfer film better and to reduce the consumable materials, provision is made, for example according to European Patent EP 0 932 501 B1, corresponding to U.S. Pat. No. 6,491,780, to move the transfer film through a pair of dancer rolls, which are moved cyclically at the same cycle rate as the channel of the transfer cylinder, so that the transfer film is braked to a speed of zero, for example, in the area of the channel. For that purpose, the two dancer rolls are coupled to each other in such a way that a transfer film web which is stored by a first, front dancer from the supply roll, which continues to move, is simultaneously released to the take-up roll by a second, rear dancer. In that way, a certain constancy of the web tension in the area of the supply and take-up rolls can be ensured. For that purpose, in order to spare the transfer film, both dancers are moved in coupled fashion in a braking direction. In that case, the film can in particular also be pulled back out of the transfer nip.

A problem occurs with such apparatuses with synchronized dancers when the transfer cylinder is enclosed by the transfer film and has rotated to such an extent that the transfer film before the transfer nip can already dip into the channel while the transfer film after the transfer nip is still set completely on the transfer cylinder and wrapped around the latter. A dancer roll which is disposed downstream of the transfer nip sees nothing of the channel already acting on the film, as a result of the transfer cylinder being set on the impression cylinder. However, a dancer roll which is provided upstream of the transfer nip already “notices” that the channel is present. The front and rear dancer rolls are substantially decoupled from each other by the transfer nip. While the web tension remains constant in the area of the rear dancer roll, it is already decreasing on the side of the front dancer roll.

Similar effects also occur when the channel is already set with its rear edge on the impression cylinder.

Different web tensions therefore arise on both sides whenever the front and rear dancer rolls are decoupled from each other. In addition, there is a general dip in the web tension on both sides when the channel is located in the area of the transfer nip.

### SUMMARY OF THE INVENTION

It is accordingly an object of the invention to provide an intermittent film drive and method, which overcome the hereinafore-mentioned disadvantages of the heretofore-known devices and methods of this general type and which avoid web tension changes to the greatest possible extent.

With the foregoing and other objects in view there is provided, in accordance with the invention, a method for transferring a transfer layer of a transfer film from a carrier film of the transfer film to a printing material. The method comprises applying adhesive to at least some areas of the printing material in an applicator; leading the printing material, together with the transfer film, through a transfer nip in a transfer unit; transferring the transfer layer to the printing material in the transfer nip; during the transfer, moving the transfer film through the transfer nip at a first speed, being substantially equal to a speed of the printing material; when no transfer is taking place, moving the transfer film through the transfer nip at a second speed being lower than the first speed; accelerating the transfer film to the first speed and braking the transfer film to the second speed by adjusting front guide elements disposed before the transfer nip and/or rear guide elements disposed after the transfer nip; and moving the front and/or rear guide elements asynchronously in relation to one another.

Therefore, in the method according to the invention, the transfer film is accelerated to the first speed and braked to the second speed through the use of adjustments of front guide elements which are provided before the transfer nip and rear guide elements which are provided following the transfer nip, with the first speed being the speed of the printing material and the second speed being the speed which the transfer film is intended to assume in the channel.

In this method according to the invention, then, guide elements, which can be provided in particular before and/or after the transfer nip, are moved asynchronously in relation to one other in order to at least reduce web tension fluctuations of the transfer film as it passes through the transfer nip. This asynchronous control is intended in particular to lead to a time-offset movement. As a result of the asynchronous control of the guide elements, even in the case of guide elements decoupled from one another, such as dancers, for example, the web tension can be kept virtually constant on both sides of the transfer nip, independently of each other. The asynchronous control includes an at least partly time-offset and/or different movement of the guide elements.

In accordance with another mode of the invention, in order to firstly maintain the web tension which is changed by an only partial effect of the channel, and to subsequently maintain the web tension which is impaired by the overall effect of the channel, the invention provides for the front and rear guide elements for respectively accelerating and braking the transfer film to be moved with two mutually different respective accelerations in respective acceleration and braking directions.

In this case, provision is in particular made for the front guide elements firstly to be accelerated highly and then less highly and for the rear guide elements firstly to be accelerated less highly and then highly. This acceleration profile is provided in order to brake the transfer film. In particular, provision can also be made in this case for an acceleration profile in the form of splice functions to be provided, in which the individual successive splice functions have lower and higher accelerations in relation to each other.

If the film is to be accelerated from a braked state to the speed of the printing material again, provision is made in this case for the front guide elements firstly to be accelerated highly and then less highly, while the rear guide elements are firstly accelerated less highly and then highly. In this case, the action of the edges of the channel is taken into account in each case. In order to avoid overswings, provision can also be made for the speed of the printing material firstly to be exceeded during the acceleration of the film, and then to have to be compensated through a corresponding negative acceleration through the use of the rear and front guide elements.

In accordance with a further mode of the invention, it is possible for the transfer film to be drawn back out of the transfer nip between the braking and the acceleration of the transfer film, through a further movement of the guide elements in the braking direction. In this way, even more film can be spared than solely by stopping the film.

In accordance with an added mode of the invention, in order to correspondingly take the times at which the channel acts on the rear and front guide elements into account, provision is made for the front guide elements to be accelerated in the braking direction with an acceleration and for the rear guide elements to be likewise accelerated in the braking direction later with a time offset with an acceleration, with the acceleration of the rear guide elements being lower than the acceleration of the front guide elements.

In accordance with an additional mode of the invention, in order to ensure a constant web tension irrespective of the guide elements on the supply roll, provision is made for a front feed to be provided in the area of the film web guidance before the front guide elements and for the drive speed of a supply roll and a take-up roll for providing the transfer film to be controlled as a function of the drive speed of the front feed. In this way, it is possible to ensure, as opposed to an apparatus without intermittent drive, that the intermittent drive speed is predefined not by the transfer nip but in the front feed, to which the drives of the supply and take-up rolls are then accordingly controlled.

In accordance with yet another mode of the invention, in order to maintain the web tension on the take-up roll, a rear feed, which is intended to move more quickly than the front feed, is provided in the area of the rear guide elements.

In accordance with yet a further mode of the invention, provision is made for the guide elements to be dancers which each have an individual drive. The drives drive the dancers asynchronously, at least from time to time, so that at least web tension changes after and before the transfer nip because of a channel of the transfer cylinder are reduced.

With the objects of the invention in view, there is also provided a film transfer apparatus, comprising an applicator for applying an adhesive, at least in some areas, to a printing material led through the applicator. A transfer unit disposed downstream of the applicator has a transfer nip for transferring a transfer layer of a transfer film from a carrier film of the transfer film to the printing material, at least in some areas. A supply roll provides the transfer film, a take-up roll accommodates used transfer film, and adjustable guide elements are disposed before and/or after the transfer nip to match a speed of movement of the transfer film, at least from time to time, to a speed of the printing material in the transfer nip. At least one drive asynchronously drives the adjustable guide elements.

Therefore, in the apparatus according to the invention, at least one drive is provided for the asynchronous drive of the adjustable guide elements. In this way, the guide elements can react independently of one another to the different web tension changes before and after the transfer nip.

In accordance with another feature of the invention, a control device is provided in order to activate the drives asynchronously, so that at least a time offset of the movement sequences of the guide elements is achieved and the web tension can be kept as constant as possible by this activation of the drives of the guide elements. In this case, the control device can be driven in accordance with a predefined control system or it can itself control the guide elements as a function of measured web tensions in the area of the guide elements or measure the web tension and further parameters and accordingly set up a learning curve relating to changing the possible asynchronous activations of the drives.

In accordance with a further feature of the invention, in particular, the control device should activate the drives in such a way that the guide elements for braking or accelerating the transfer film are in each case driven with at least two different accelerations.

In accordance with an added feature of the invention, both the take-up roll and the supply roll are mounted on a friction shaft, front and rear feeds are provided in the regions of the respective front and rear guide elements and the take-up roll and/or the supply roll are driven by a drive which sets the drive speed as a function of the speed of the front feed.

In this way, control of the drive speeds of the take-up and supply rolls in accordance with the speed of movement of the printing material, is no longer necessary.

In accordance with an additional feature of the invention, the guide elements are simply dancer rolls.

In accordance with a concomitant feature of the invention, further guide elements are provided which lead the transfer film around a transfer cylinder with a wrap angle a preferably being an angle of more than 10 degrees. In this way, as opposed to substantially tangential guidance of the transfer film through the transfer nip, a large amount of space, in which further apparatuses can be provided, can be made available in the area of the transfer nip.

Other features which are considered as characteristic for the invention are set forth in the appended claims.

Although the invention is illustrated and described herein as embodied in an intermittent film drive and method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view of the structure of a film transfer unit with an intermittent drive;

FIG. 2 is an reduced, cross-sectional view of a film transfer apparatus having an appropriate film transfer unit;

FIG. 3 is a cross-sectional view showing different states of a channel; and

FIG. 4 is a group of three graphs illustrating film web speed, web tension and dancer speed.

### DETAILED DESCRIPTION OF THE INVENTION

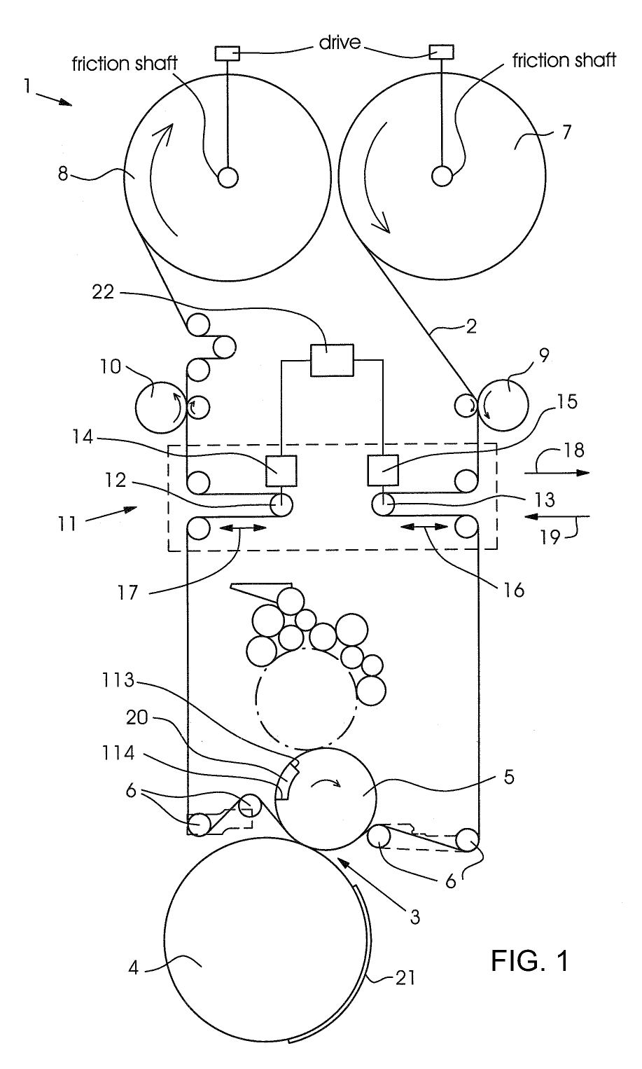

Referring now to the figures of the drawings in detail and first, particularly, to FIG. 1 thereof, there is seen a film transfer unit 1, in which a transfer film 2 is led through a transfer nip 3.

The transfer nip 3 is formed by a transfer cylinder 5 and an impression cylinder 4. The transfer film 2 is unwound from a supply roll 7 and pulled by a front feed 9 in the direction of the transfer nip 3. In this case, the supply roll 7 is located on a non-illustrated friction shaft and is driven at a speed which is lower than a speed of a printing material 21. The supply roll 7 is driven by the friction shaft. The transfer film 2 is pulled off the supply roll 7 by the front feed 9, with rolls of the front feed 9 being driven at a higher speed than the friction shaft of the supply roll 7. However, the front feed 9 is always still operated at a lower speed than the speed of the printing material 21.

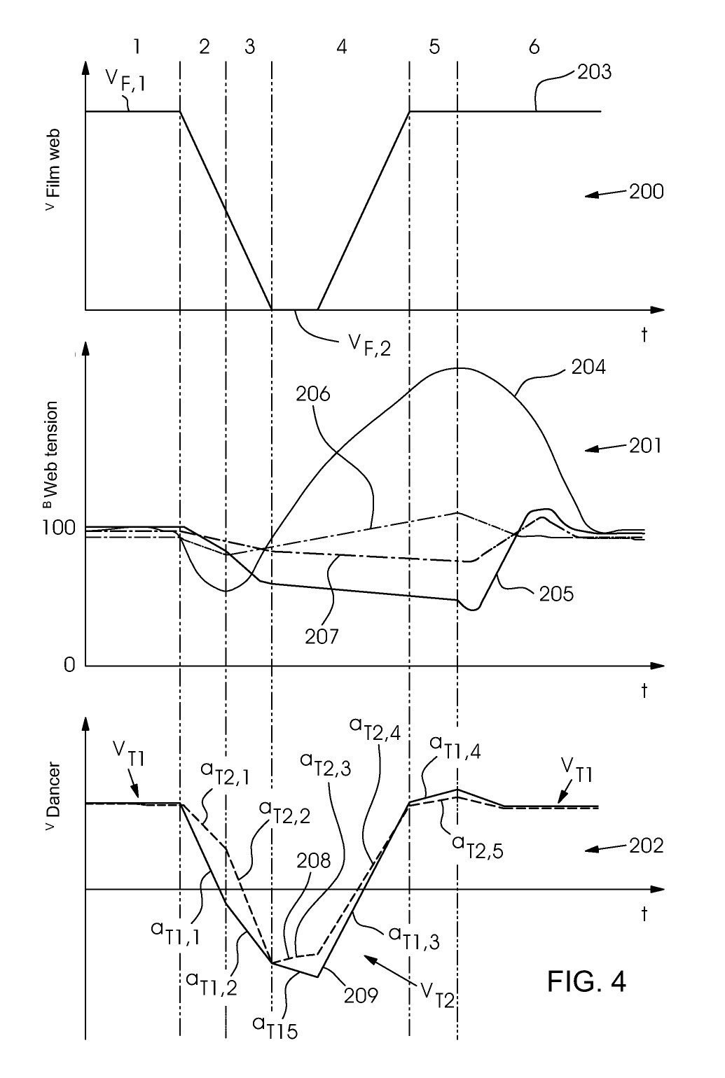

The unwound transfer film 2 is guided over a front guide element in the form of a front dancer 13 of an intermittent drive module 11 and over further deflection rollers 6 through the transfer nip 3 in such a way that it forms a wrap angle a with the transfer cylinder 5 (see FIG. 4). After the transfer nip 3, the transfer film 2 is deflected further over deflection rollers 6 and fed to a rear guide element in the form of a rear dancer 12, which deflects the transfer film 2 and feeds it to a rear feed 10, which is faster than the front feed 9. The film 2 is deflected onto a take-up roll 8 by the rear feed 10. The take-up roll 8 is also mounted on a friction shaft, which is driven faster than the rear feed 10. At least the friction shaft is driven in such a way that the peripheral speed of the take-up roll 8 is higher than the speed of the rear feed 10. In this way, slippage occurs between the friction shaft and the actual take-up roll 8. The same is true of the supply roll 7.

The printing material 21 is led through the transfer nip 3 over the impression cylinder 4 together with the transfer film 2. During the transfer of a non-illustrated transfer layer, the transfer film 2 and the printing material 21 are at the same speed.

The transfer cylinder 5 has a non-illustrated printing blanket which is clamped over a channel 20. The channel 20 is also provided in order to be able to accommodate possible grippers on the side of the impression cylinder 4.

When a front edge 113 of the channel 20 comes into the transfer nip 3, web tension between the dancer 13 and the transfer nip 3 collapses. During the transfer of a transfer layer to the printing material 21, the sum of the speed of the front feed 9 and of the front dancer 13 gives the speed of the printing material 21. For this reason, the dancer 13 is moved in an acceleration direction 18 along a path which is identified by a double arrow 16. As a result of contact made between the front edge 113 of the channel 20 and the impression cylinder 4, the front dancer 13 is decoupled from the rear dancer 12. In order then to compensate for the diminishing web tension, provision is made for the front dancer 13 to be driven by a motor 15 in such a way that it is firstly accelerated highly in a braking direction 19. In this way, a constant web tension is achieved in this area. For this purpose, a control device 22 acts appropriately on the motor 15 of the front dancer 13. Once the channel 20 is completely in the area of the transfer nip 3, the dancer 13 is moved in the braking direction 19 with a lower acceleration, so that the transfer film 2 comes to a standstill or is pulled back.

When the channel 20 is “seen” for the first time by the dancer 12, the rear dancer 12 is firstly accelerated in the braking direction 19 with a lower acceleration in order to compensate for this dip and later accelerated with a higher speed, so that a standstill of the transfer film 2 can be achieved. For this purpose, too, the control device 22 is connected to the motor 14 of the rear dancer 12.

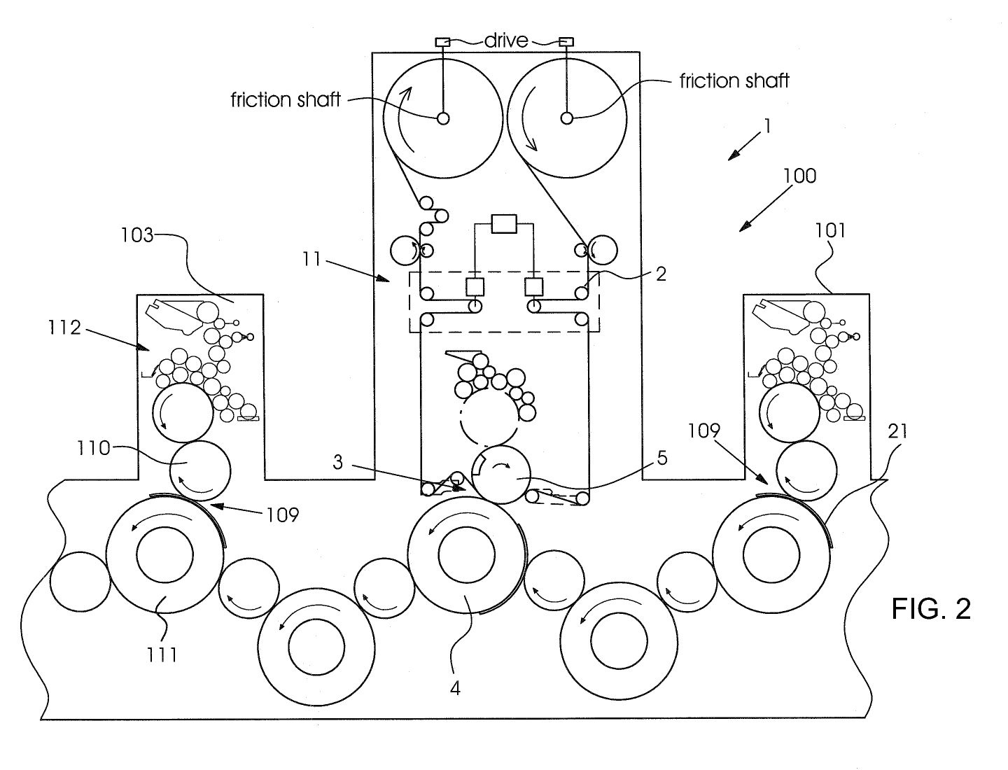

FIG. 2 shows a portion of a film transfer apparatus 100. Such a film transfer apparatus 100 can be assembled inside a printing press. A sheet 21 is transported through an applicator 101, which is a conventional printing unit of a printing press and through a press nip 109. Adhesive is applied to part of the printing material 21 in this press nip 109. The sheet 21 is then transported onward through the film transfer unit 1. As described, the sheet 21 is led through the transfer nip 3, in which it removes the transfer layer of the transfer film 2 in the areas of the transfer film 2 in which it itself has had adhesive applied.

The sheet 2 which is treated in this way can then be transported onward through the printing press, i.e. through the film transfer apparatus, so that it is moved to a further adjoining printing unit 103, which once more has a press nip 109, that is formed by a blanket cylinder 110 and an impression cylinder 111. The printing unit 103 additionally has an inking unit 112. The sheet 21 to which a transfer layer has been applied can then be overprinted conventionally in the printing unit 103.

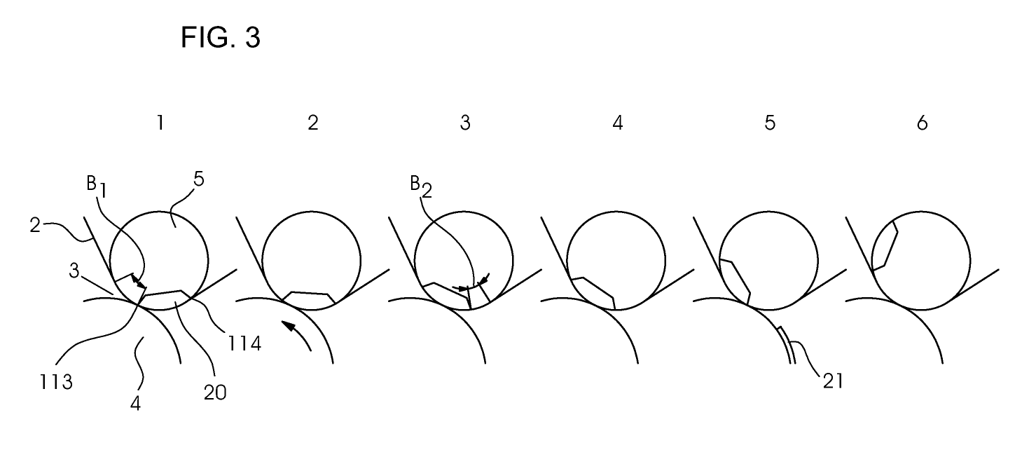

FIG. 3 illustrates six different successively assumed states of the transfer cylinder 5 and the impression cylinder 4 of the transfer nip 3. The transfer film 2 has wrapped around the transfer cylinder 5 and thus, on the rear side of the transfer nip 3, in an section B₁, still touches the surface of the transfer cylinder 5 while on the opposite side, which is to say before the transfer nip 3, the transfer film 2 is already dipping into the channel 20 of the transfer cylinder 5. The front and the rear side of the film web are decoupled from each other by the transfer nip 3. As long as the front edge 113 of the channel 20 has not yet come into the transfer nip 3, the film is not yet driven intermittently. At the instant at which the front edge 113 dips into the transfer nip 3, firstly the transfer film 2 should be braked in order to reduce consumption and, secondly, since the front side with the front dancer 13 then “sees” the channel 20, a dip in the web tension occurs in the area of the front dancer 13, so that this web tension change should also be compensated.

FIG. 4 illustrates three graphs 200, 201, 202 which represent the course (200) of the film web speed, the course (201) of the web tension after and before the press nip and the speed (202) of the dancers.

The influence of the different positions of the channel 20 from the sections 1 to 6 of FIG. 3 is correspondingly illustrated in the graphs 200 to 202.

Before the front edge 113 of the channel 20 dips into the transfer nip 3, as in the illustration in section 1 of FIG. 3, the film web is moved at a constant speed. The web tension is maintained and the two dancers are moved uniformly in one direction. The dancers are moved at a speed which, together with the speed of the front feed 9, gives the sheet speed of the sheet 21.

Once the front edge 113 dips into the transfer nip 3 then, as is illustrated in graph 201, there is a dip in the web tension on the front dancer 13. As is illustrated in graph 200, from this instant the film web speed should also be reduced. In order to reduce the film web speed and at the same time to compensate for the web tension loss, the front dancer 13 according to graph 202 is accelerated in the braking direction 19 with a high acceleration a_{T1,1}. The rear dancer 12 still sees substantially no dip in the web tension but should also reduce the film web speed. It is therefore accelerated in the braking direction 19 with a lower acceleration a_{T2,1}. This acceleration of the rear dancer 12 is offset slightly in time with respect to the acceleration of the front dancer 13.

In the illustration in section 2 of FIG. 3, the situation is shown where the channel 20 itself is located in the transfer nip 3. Additional web tension compensation is no longer necessary in this case for the front dancer 13. It is accelerated only in accordance with the reduction in the web speed with the acceleration a_{T1,2}, which is lower than the first acceleration a_{T1,1}. According to the illustration in section 3 of FIG. 3, the channel 20 is located completely in the transfer nip 3. In this case, a web tension change on the rear dancer 12 is also to be noticed and is reduced through the use of a higher acceleration a_{T2,2} in the braking direction 19 of the rear dancer 12 in addition to the intermittent drive.

The accelerations described above always also relate substantially to the intermediate areas illustrated between the sections 1 to 6.

As is shown in the illustrations in sections 2 and 3 of FIG. 3, in section 2 no portion of the surface of the transfer cylinder 5 is set in contact with the transfer film 2 in the front area. This changes toward the illustrations in section 3, where an section B₂ is set on the transfer cylinder 5. In this way, the web tension in the area of the front dancer 13 is increased, which is illustrated in graph 201. This also leads to the acceleration a_{T1,2} being lower than the previous acceleration of the front dancer 13.

As can be seen in the illustration in section 4 of FIG. 3, the section B₂ becomes larger and larger, which means that the web tension increases further, as is illustrated in graph 201 of FIG. 4. This is compensated through the use of a further reduction of the acceleration of the front dancer 13 according to graph 202 of FIG. 4. Since the web in this case is itself intended to come to a standstill according to graph 200 of FIG. 4, a movement in the braking direction 19 of the front dancer 13 is always still necessary. However, it is less highly retarding, according to the acceleration a_{T1,5}.

According to FIG. 4, graph 200, the transfer film 2 is accelerated once more in the area of the position of the illustration in section 4 of FIG. 3 with the channel 20 in the transfer nip 3 so that, as the printing material 21 passes through the transfer nip 3, the transfer film 2 reaches the web speed of the printing material 21 again. For this purpose, the front and rear dancers 12 and 13 are accelerated in the acceleration direction 18. In this case, the rear dancer is already accelerated earlier in the acceleration direction 18 over its path 117 than the front dancer 13, in order to maintain the web tension. This is illustrated in graph 202 of FIG. 4. The section B₁, which still makes contact with a part of the transfer film 2, is always small in this area, so that the web tension on the rear dancer 12 dips and must be compensated by a corresponding acceleration. Then, both the rear dancer and the front dancer are accelerated in the acceleration direction 18 with increased accelerations a_{T1,3} and a_{T2,4} until, in the illustration in section 5 of FIG. 3, in which a rear edge 114 dips into the transfer nip 3, the web tension changes of the transfer film web 2 have to be compensated again. As is illustrated in graph 201, a front web tension 204 runs through a maximum in this case. This is produced because the rear edge 114 of the channel 20 carries the transfer film 2 along with it, as is shown in the illustrations in sections 3 to 5 of FIG. 3. In order to compensate for this increased web tension, provision is made for the front and the rear dancers 12, 13, after reaching the desired dancer speed for the desired film web speed, to also always be accelerated in the acceleration direction 18 with an acceleration a_{T1,4} and a_{T2,5,} although this is now reduced, until when, according to the illustration in section 6 of FIG. 3, the transfer film 2 is set on the transfer cylinder 5 over the entire wrap angle, the dancers are accelerated once more oppositely in the braking direction 19 to such an extent that the desired speed of the dancers 12, 13 which is necessary in order to ensure the film web speed V_{F,1} is reached.

In FIG. 4, an idealized intermittent drive 203 for the speed V_{F} of the film web is illustrated in graph 200.

The graph 201 shows the course 204 of the web tension before the transfer nip and a course 205 of the web tension after the transfer nip, firstly as would be present without any compensation by the accelerations to compensate for the web tension changes through the use of the front and rear dancers 13, 12 and, secondly with reduced web tension changes in accordance with dashed lines 206, 207 as would be present for a front web tension area 206 and for a rear web tension area 207 with compensation.

FIG. 4 additionally shows the graph 202 for the course of the speed V_{T} of the different front and rear dancers 13, 12. In the normal case, as film is applied, they have a positive speed V_{T1}, which is braked to a negative speed V_{T2}, i.e. a movement in the braking direction 18. The different sections for braking and accelerating the front and rear dancers 13, 12 are identified by the sectors which are assigned to the illustrations in sections 1 to 6 of FIG. 3 and are identified by the accelerations a_{T1/2,1 to 5}. In this case, the dashed line 208 shows the movement sequence for the rear dancer 12, and the dashed line 209 shows the movement sequence for the front dancer 13.

As can be seen, as a result of the superimposition of the simple acceleration for the intermittent drive with an acceleration to reduce the web tension through the use of the front and rear dancers 12, 13, as is illustrated in graph 202, the web tensions 206, 207 are reduced sharply before and after the transfer nip 3.

As a result of using friction shafts in the supply and take-up rolls 7, 8, it is of course also possible to use a plurality of partial film webs of the transfer film 2 beside one another. If each partial film web is assigned an individual front and/or rear feed 9, 10, these partial film webs can also be driven intermittently independently of one another, depending on the subject.

1. A method for transferring a transfer layer of a transfer film from a carrier film of the transfer film to a printing material, the method comprising the following steps:
applying adhesive to at least some areas of the printing material in an applicator;
leading the printing material, together with the transfer film, through a transfer nip in a transfer unit;
transferring the transfer layer to the printing material in the transfer nip;
during the transfer, moving the transfer film through the transfer nip at a first speed, being substantially equal to a speed of the printing material;
when no transfer is taking place, moving the transfer film through the transfer nip at a second speed being lower than the first speed;
accelerating the transfer film to the first speed and braking the transfer film to the second speed by adjusting at least one of front guide elements disposed before the transfer nip or rear guide elements disposed after the transfer nip; and
moving at least one of the front or rear guide elements asynchronously in relation to one another.

2. The method according to claim 1, which further comprises carrying out the step of moving at least one of the front or rear guide elements for respectively accelerating and braking the transfer film to the respective first and second speeds with two mutually different respective accelerations in respective acceleration and braking directions.

3. The method according to claim 2, which further comprises carrying out the step of braking the transfer film by moving at least one of the front or rear guide elements in a first movement section with a first acceleration and in a second movement section with a second acceleration, the magnitude of the second acceleration being smaller or greater than the magnitude of the first acceleration and both accelerations pointing in the same direction.

4. The method according to claim 2, which further comprises carrying out the step of accelerating the transfer film by moving the at least one of the front or rear guide elements in a first movement section with a first acceleration and in a second movement section with a second acceleration, the magnitude of the second acceleration being smaller or greater than the magnitude of the first acceleration and both accelerations pointing in the same direction.

5. The method according to claim 3, which further comprises drawing the transfer film back out of the transfer nip between the braking and the acceleration of the transfer film, by a further movement of the guide elements in the braking direction.

6. The method according to claim 4, which further comprises drawing the transfer film back out of the transfer nip between the braking and the acceleration of the transfer film, by a further movement of the guide elements in the braking direction.

7. The method according to claim 3, which further comprises:
carrying out the step of accelerating the transfer film by moving the at least one of the front or rear guide elements in a first movement section with a first acceleration and in a second movement section with a second acceleration, the magnitude of the second acceleration being smaller or greater than the magnitude of the first acceleration and both accelerations pointing in the same direction; and
drawing the transfer film back out of the transfer nip between the braking and the acceleration of the transfer film, by a further movement of the guide elements in the braking direction.

8. The method according to claim 3, which further comprises firstly accelerating the front guide elements in the braking direction with an acceleration and secondly accelerating the rear guide elements in the braking direction later with a time offset with an acceleration, and the acceleration of the rear guide elements being lower than the acceleration of the front guide elements.

9. The method according to claim 1, which further comprises providing a front feed in a film web guidance area before the front guide elements, and controlling a drive speed of a supply roll and a take-up roll for providing the transfer film as a function of a drive speed of the front feed.

10. The method according to claim 9, which further comprises providing a rear feed in an area after the rear guide elements, and driving the rear feed faster than the front feed.

11. The method according to claim 1, which further comprises providing the guide elements as dancers each having an individual drive, and driving the dancers asynchronously with the drives, at least from time to time, for at least reducing web tension changes after and before the transfer nip because of a channel of a transfer cylinder.

12. A film transfer apparatus, comprising:
an applicator for applying an adhesive, at least in some areas, to a printing material led through said applicator;
a transfer unit disposed downstream of said applicator and having a transfer nip for transferring a transfer layer of a transfer film from a carrier film of the transfer film to the printing material, at least in some areas;
a supply roll for providing the transfer film;
a take-up roll for accommodating used transfer film; and
adjustable guide elements disposed at least one of before or after said transfer nip to match a speed of movement of the transfer film, at least from time to time, to a speed of the printing material in said transfer nip; and
at least one drive for asynchronously driving said adjustable guide elements.

13. The film transfer apparatus according to claim 12, which further comprises a control device for asynchronous activation of said at least one drive, to achieve at least a time offset of movement sequences of said guide elements.

14. The film transfer apparatus according to claim 13, wherein said control device activates said at least one drive for driving each of said guide elements to brake or accelerate the transfer film with at least two different accelerations.

15. The film transfer apparatus according to claim 12, which further comprises:
friction shafts, each of said take-up and supply rolls being mounted on a respective one of said friction shafts;
front and rear feeds each disposed in vicinity of a respective one of said front and rear guide elements; and
at least one drive for driving at least one of said take-up and supply rolls and setting a drive speed as a function of a speed of said front feed.

16. The film transfer apparatus according to claim 12, wherein said guide elements are dancer rolls.

17. The film transfer apparatus according to claim 10, which further comprises a transfer cylinder, and further guide elements leading the transfer film around said transfer cylinder with a wrap angle.

18. The film transfer apparatus according to claim 17, wherein said wrap angle is more than 10°.
